(19) United States
(12) Patent Application Publication
(10) Pub. No.: US 2024/0088745 A1
(43) Pub. Date: Mar. 14, 2024

(54) ELECTRIC MACHINE THREE-PHASE STATOR

(71) Applicant: FERRARI S.P.A., Modena (IT)

(72) Inventors: Davide FERRARA, Modena (IT); Paolo FAVERZANI, Modena (IT); Luca POGGIO, Modena (IT)

(21) Appl. No.: 18/462,984

(22) Filed: Sep. 7, 2023

(30) Foreign Application Priority Data
Sep. 12, 2022 (IT) 102022000018492

(51) Int. Cl. H02K 5/22; H01R 13/52; H01R 43/20; H02K 3/52; H02K 15/00

(52) U.S. Cl. CPC H02K 5/225; H01R 13/5202; H01R 43/20; H02K 3/522; H02K 15/0062; H02K 2203/09

(57) ABSTRACT

An electric machine three-phase stator has a casing and three busbars that carry respective contacts, within and at an axial end of this casing; the contacts are electrically connected to respective outer terminals;
the stator is provided with an electrical connector, which is coupled, in a fluid-tight manner, to the same casing and has three connection conductor elements; the outer ends of the three conductor elements define the above-mentioned outer terminals, while the inner ends of the three conductor elements are respectively fixed to the contacts by means of a fixing system; the busbars, the contacts, fixing system, and the inner ends of the three conductor elements are embedded in an encapsulation material.

### CROSS-REFERENCE TO RELATED APPLICATIONS

This patent application claims priority from Italian patent application no. 102022000018492 filed on Sep. 12, 2022, the entire disclosure of which is incorporated herein by reference.

### TECHNICAL FIELD

This invention relates to an electric machine three-phase stator.

This invention is advantageously applied to an automotive electric machine that is installed on a vehicle and can be used as a motor (absorbing electricity and generating mechanical torque) or as a generator (converting mechanical energy into electricity).

### PRIOR ART

A rotating, automotive electric machine comprises a shaft, which is mounted so it can rotate around a central rotation axis, a rotor, generally with permanent magnets fitted to the shaft to rotate together with the shaft, and a stator arranged around the rotor to enclose the rotor inside it.

The stator is generally provided with an outer electrical connector that has multiple connection elements connected to the inner busbars that collect the electrical current from the stator windings. In general, these busbars are encased or embedded in a resin that performs the function of insulating the electrical components of the stator in relation to external water and humidity, and also the function of transmitting and, thus, dissipating the heat produced by the busbars.

There is a need to perfect the known solutions just described, in particular to improve their water tightness, to simplify the methods for coupling the electrical connection elements to the busbars, and to reduce the dimensions of the stator and, thus, of the electric machine, in the axial direction.

DE10316435A1 discloses an electric motor with a connector having an injection moulded portion, which is coupled, via two gaskets, respectively to a housing and an end cover of the motor.

### DESCRIPTION OF THE INVENTION

The purpose of this invention is to provide an electric machine three-phase stator that fulfils the needs mentioned above in a relatively simply and economical way.

According to this invention, an electric machine three-phase stator is provided, as defined in independent claim 1. This invention also relates to a method for manufacturing a three-phase stator, according to claim 7. Preferred embodiments of this invention are then defined in the attached dependent claims.

### BRIEF DESCRIPTION OF THE DRAWINGS

This invention will now be described with reference to the attached drawings that illustrate a preferred non-limiting embodiment thereof:

FIG. 1 is a perspective view of a preferred embodiment of the three-phase stator for an electric machine according to this invention;

FIG. 2 is a front view of the stator in FIG. 1;

FIG. 3 is a cross section, according to the plane section III-III in FIG. 2; and

FIG. 4 is similar to FIG. 1 and shows the stator with some parts removed for clarity.

### PREFERRED EMBODIMENTS OF THE INVENTION

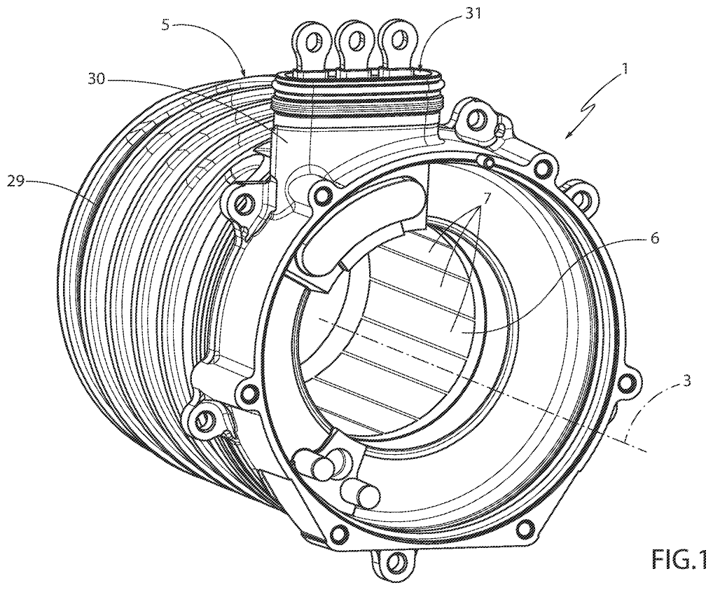

In FIG. 1, the reference number 1 indicates, as a whole, a three-phase stator for a synchronous electric machine, in particular for automotive applications, for example a reversible one (i.e. an electric machine that can function both as an electric motor absorbing electricity and generating mechanical torque, and as an electrical generator, absorbing mechanical energy and generating electricity).

The stator 1 extends along an axis 3, which corresponds to the rotation axis of the rotor of the electric machine (not illustrated), and basically has a cylindrical, tubular shape so as to enclose this rotor inside.

The stator 1 comprises a casing 5 and a magnetic core 6 arranged in the casing 5 and comprising multiple magnetic poles 7. Around each magnetic pole 7, a corresponding coil that has two ends is arranged in a known way not illustrated in detail.

The ends of the coils are all arranged on one axial side of the core 6, i.e. on the left side with reference to FIG. 3, so that they can be connected to each other to create a three-phase winding. In particular, the coils are connected, in a way not illustrated in detail, to three busbars 13, which have, in particular, a ring shape, whether open or closed, for example a circular shape. According to the preferred embodiment illustrated, each busbar 13 consists of a flat plate that is arranged perpendicularly to the axis 3 and, as mentioned above, has a circular shape (for example, like a smaller or bigger arc of a circle). The busbars 13 are coaxial to each other in relation to the axis 3, and are axially packed by interposing insulating supports, which are also coaxial in relation to the axis 3.

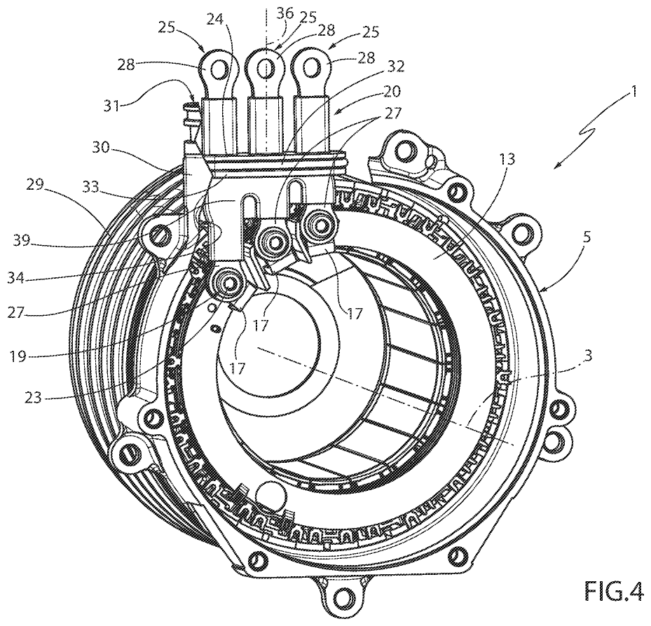

With reference to FIG. 4, the busbars 13 carry corresponding contacts 17 that define the terminals of the above-mentioned three-phase winding and are connected, via corresponding fixing systems 19, to an electrical connector 20, which defines the connection of the stator 1 and, thus, of the electric machine outside. The contacts 17 are preferably defined by respective folded portions of the busbars 13. In other words, each contact 17 is a folded plate, which is of a single piece with the corresponding busbar 13.

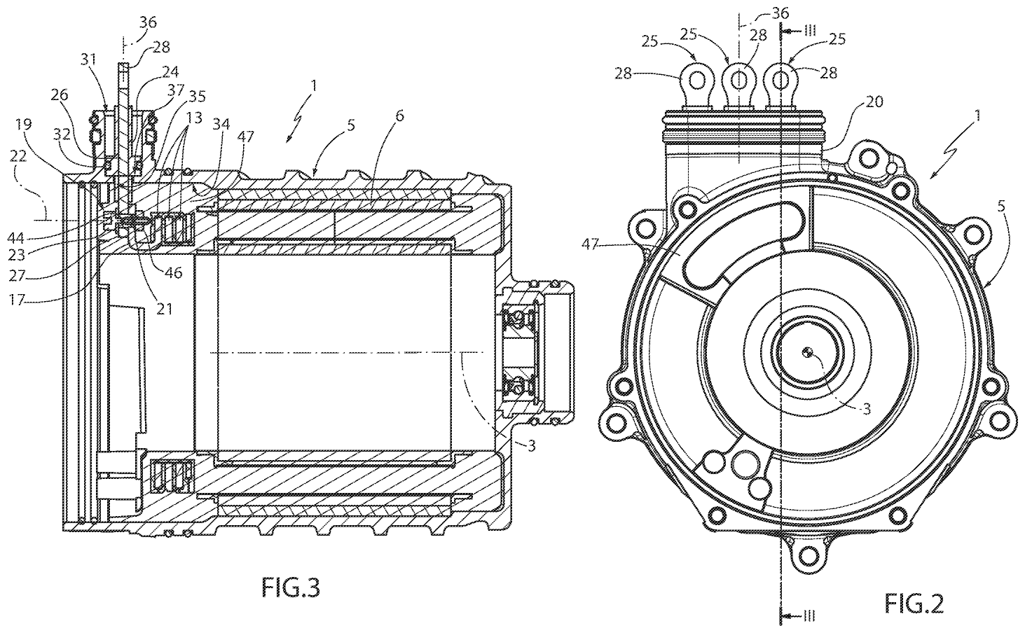

As can be seen in FIG. 2, each contact 17 defines an eyelet, i.e. it has a through hole 21, which is formed along an axis 22 parallel and spaced apart in relation to the axis 3 and is engaged by a corresponding screw 23, which is part of the above-mentioned fixing system 19, as will be explained better below.

With reference, again, to FIG. 4, according to one aspect of this invention, the electrical connector 20 comprises an insulating support element 24 and three connection conductor elements 25 that are supported by the insulating support element 24. The connection conductor elements 25 are spaced apart from each other and, preferably, are not defined by wires, but are defined by basically stiff elements, i.e. less flexible than wires. For example, they are defined by flat sheets, arranged along the same plane that is orthogonal to the axis 3. Alternatively, the connection conductor elements 25 could have a different shape and/or structure, for example be in the shape of bars or pins. As an additional variant, the connection conductor elements 25 could be flexible, for example be defined by elements made of laminated copper, with their thickness in the order of tenths of millimetres, to be able to recover any tolerances along the axis 3.

The insulating support element 24 preferably consists of polymer material that, for example, is overmoulded on the connection conductor elements 25 (alternatively, the connection conductor elements 25 could be inserted in seats of the insulating support element 24). More specifically, each connection conductor element 25 comprises an intermediate portion 26 (FIG. 3) embedded in the insulating support element 24 and two end portions, arranged opposite each other, indicated by the reference numbers 27 and 28 respectively, which are not covered by the intermediate portion 26 and are arranged one inside the other outside the casing 5.

The casing 5 preferably comprises a cylindrical portion 29, which is coaxial to the axis 3, and an outer portion defined, in particular, by an appendage 30 that projects radially from the cylindrical portion 29 and defines a seat or housing pocket 31, engaged, in a fluid-tight manner, by the insulating support element 24. This seal is ensured, in the specific example illustrated, by a gasket ring 32, which surrounds an intermediate portion 33 of the insulating support element 24 and is placed between the intermediate portion 33 and an annular wall that defines the appendage 30.

Alternatively, the seal may be ensured by a part of the same insulating support element 24 and/or by the same appendage 30, i.e. by interference coupling between the portion 33 of the insulating support element 24 and the annular wall that defines the appendage 30.

Alternatively, the seal may be ensured by a sealant arranged in the pocket 31.

With reference to FIG. 3, the housing pocket 31 communicates with a volume or space 34 provided inside the casing 5 via a passage 35. The latter is formed along a direction 36, which is oriented orthogonally to the axis 3, in particular is spaced apart and, thus, tangential to the axis 3, and is parallel in relation to the three connection conductor elements 25.

The portion 33 of the insulating support element 24 preferably rests along the direction 36, against a surface 37 that defines the bottom of the housing pocket 31. In particular, the insulating support element 24 comprises, in addition, a portion 39 (FIG. 4) that engages the passage 35 and projects starting from the portion 33 inside the space 34 in the casing 5.

The portions 28 of the connection conductor elements 25 define the outer terminals of the stator 1. The terminals 28 preferably project (parallel to the direction 36) beyond the appendage 30, i.e. outside the housing pocket 31. Alternatively, the terminals 28 could also be housed inside the housing pocket 31. In the specific case illustrated, the terminals 28 define respective eyelets, i.e. have respective through holes, for example with axes that are parallel to the axis 3, to be permanently connected, in use, to electrical wiring (not illustrated).

Similarly, with reference to FIG. 3, in this particular solution, the end portions 27 of the connection conductor elements 25 define respective eyelets, i.e. have respective through holes 44, which are each coaxial with a corresponding hole 21 along the corresponding axis 22 and are engaged, respectively, by the screws 23. In other words, the screws 23 extend along the axes 22 and fix the end portions 27 of the connection conductor elements 25 to the respective contacts 17. For example, each fixing system 19 comprises a nut 46 that is screwed onto the threaded shank of the screw 23 and is tightened axially towards a face of the corresponding contact 17, on the side where the busbars 13 are, while the head of the screw 23 is arranged on the opposite axial side (where the end portions 27 are arranged).

According to variants not illustrated, the screws 23, the nuts 46, and/or the holes 44 and/or 21 may be absent and replaced with a different fixing system, for example riveted pins, or welding (for example laser welding) to fix the connection conductor elements 25 to the busbars 13.

According to one aspect of this invention, the busbars 13, the contacts 17, the fixing systems 19, and the end portions 27 of the electrical connector 20 are embedded in a body 47 consisting of electrically insulating material, typically resin. The material of the body 47 is preferably chosen so as to be a heat conductor and, thus, transmit and dissipate heat from these electrical components. In particular, according to this type of solution, the body 47 defines a so-called encapsulation made of resin. More specifically, during the manufacture of the stator 1, the body 47 is formed using a technique called “potting”, i.e. filling the space 34 available around the above-mentioned electrical components, using resin casting in fluid form (that will subsequently be subject to hardening via curing). This filling operation is carried out after the following operations:
the electrical connector 20 is inserted along the direction 36 in the housing pocket 31 and through the passage 35; during this insertion operation, the insulating support element 24 is coupled in a fluid-tight manner to the casing 5 (in particular, to the appendage 30 described above by way of example); the wall that defines the appendage 30 also carries out a guiding function during insertion; this insertion ends when the portion 33 of the insulating support element 24 abuts against the bottom surface 37: at this point, the end portions 27 of the connection conductor elements 25 are arranged in positions aligned with the respective contacts 17, along the axes 22;
after this positioning, the end portions 27 are fixed to the respective contacts 17 using screws 23 or using other techniques (for example, welding).

In particular, the connector 20 is stiff enough to keep the three connection conductor elements 25 in relatively stable positions during insertion and fixing.

During filling, it is clear how the passage 35 is plugged by the insulating support element 24 of the connector 20, thanks to the fluid tightness provided between the insulating support element 24 and the casing 5 (i.e. thanks to the gasket ring 32, in the specific example illustrated). Therefore, thanks to the connector 20, which is an element distinct from the encapsulating resin and performs the function of a plug, the resin does not flow out of the casing 5 through the passage 35 during filling and during the subsequent resin curing step.

From the above, the advantages of the stator solution envisaged according to this invention should be clear.

First of all, the radial arrangement of the passage 35 and of the connection conductor elements 25 makes it possible to significantly reduce the axial dimensions of the stator 1, compared to known solutions in which the electrical connection components for the outlet of the three phases are oriented parallel to the axis 3. Another result is that the space 34 to be filled with the material of the body 47 has relatively small dimensions. At the same time, the encapsulation defined by the body 47 has the end portions 27 of the electrical connector 20 and the fixing systems 19, so that this solution ensures better water tightness compared to the known solutions in which only the busbars 13 are encapsulated.

This complete encapsulation also enables improvement in the thermal dissipation of heat produced by the electrical components, given that the material that this body 47 consists of is chosen to be a thermal conductor. In turn, the greater dissipation could lead to accepting greater production of heat by the busbars 13 and, thus, could enable, in the design phase, a reduction in the thickness of these busbars 13 with a consequent, advantageous reduction of the weight of the stator 1.

In addition, the particular structure of the electrical connector 20 makes it possible to avoid wiring, or other complex electrical connection systems, and defines a rigid solution that remains in a stable and safe position during fixing to the contacts 17, and during the filling of the space 34 with the resin to form the body 47. In particular, the structure of the electrical connector 20 and the complete encapsulation in the resin defining the body 47 make it possible to stiffen the solution proposed compared to the known solutions, for example those where there is connection wiring between the busbars and the outer terminals, with a consequent improvement in the resistance of the stator 1 to mechanical stresses during use.

In addition, in the specific solution proposed in the attached drawings, the fixing to the contacts 17 is relatively simple: in fact, the screws 23 are easily screwed, thanks to the fact that these screws 23 are parallel to the axis 3 and have their head axially facing outside.

From the above, it is also clear how they modifications may be made to the stator 1, as described above, or variations produced thereof, without, for this reason, departing from the protective scope as defined by the attached claims.

In particular, the shape and size of the various components illustrated could be different to those illustrated, by way of example.

1. An electric machine three-phase stator (1), extending along an axis (3) and comprising:
a casing (5);
three busbars (13), which carry respective contacts (17), within and at an axial end of said casing (5);
three outer terminals (28);
fixing means (19) to electrically connect said contacts (17) to said outer terminals (28);
an encapsulation material (47), in which said busbars (13) are embedded;
characterized by comprising an electrical connector (20) distinct from said encapsulation material (47), coupled to said casing (5) in a fluid-tight manner and comprising three connection conductor elements (25), which have respective outer ends defining said outer terminals (28) and respective inner ends (27) inside said casing (5); said inner ends (27) being respectively fixed to said contacts (17) by means of said fixing means (19);
wherein said contacts (17), said fixing means (19) and said inner ends (27) are embedded in said encapsulation material (47);
wherein said casing (5) comprises an outer portion (30) defining a housing pocket (31), and
wherein said electrical connector (20) comprises an insulating support element (24), which supports said connection conductor elements (25) and engages said housing pocket (31) in a fluid-tight manner.

2. The three-phase stator according to claim 1, wherein said connection conductor elements (25) are parallel to a direction (36) extending orthogonally to the axis (3) of the three-phase stator.

3. The three-phase stator according to claim 1, wherein said connection conductor elements (25) extend through a passage (35) of said casing (5); said passage (35) being made along a direction (36) extending orthogonally to the axis (3) of the three-phase stator.

4. The stator according to claim 2, wherein said direction (36) is spaced apart from the axis (3) of the three-phase stator.

5. The three-phase stator according to claim 1, wherein said connection conductor elements (25) are arranged along a plane that is orthogonal to the axis (3) of the three-phase stator.

6. The stator according to claim 1, wherein said insulating support element (24) is coupled to said outer portion (30) through a gasket ring (32) or through a sealant.

7. A method to manufacture a three-phase stator according to claim 1, the method comprising the following steps:
inserting said electrical connector (20) into said housing pocket (31); the inserting step comprising the operations of
a) coupling said electrical connector (20) to said casing (5) in a fluid-tight manner so as to close said housing pocket (31), and
b) placing said inner ends (27) at said contacts (19), respectively;
fixing said inner ends (27) to said contacts by said fixing means (19) after the inserting step;
after the fixing step, filling an inner space (34) in said casing (5) with an encapsulation material (47) so as to embed said busbars (13), said contacts (17), said fixing means (19) and said inner ends (27).

8. The method according to claim 7, wherein the insertion of said electrical connector (20) takes place along a direction (36) extending orthogonally to the axis (3) of the three-phase stator.

9. The method according to claim 8, wherein the insertion of said electrical connector (20) comprises the operation of engaging said insulating support element (24) in said housing pocket (31), by coupling said insulating support element (24) to said outer portion (30) through a gasket ring.

10. The method according to claim 7, wherein the filling step is carried out through potting.
